(19) United States
(12) Patent Application Publication
(10) Pub. No.: US 2025/0199882 A1
(43) Pub. Date: Jun. 19, 2025

(54) REPEATED EVENT STATUS WITH HOST MONITORING

(71) Applicant: INTERNATIONAL BUSINESS MACHINES CORPORATION, ARMONK, NY (US)

(72) Inventors: Richard Bordoli, Winchester (GB); Josh Peake, Waterlooville (GB); Timothy Andrew Moran, Southampton (GB); Dominic Tomkins, Alton (GB)

(21) Appl. No.: 18/416,103

(22) Filed: Jan. 18, 2024

(30) Foreign Application Priority Data
Dec. 19, 2023 (GB) 2319536.5

(51) Int. Cl. G06F 9/54

(52) U.S. Cl. CPC G06F 9/542

(57) ABSTRACT

A computer implemented method, system, and computer program product for handling target event status, the method comprising: determining at a target, a condition; analysing, by the target, the condition to determine a first event status associated with the condition; in response to receiving, at the target, a first command of a set of commands from an initiator, providing, by the target, the first event status to the initiator; monitoring, by the target, the condition; in response to determining that the condition is not resolved, determining, by the target, a second event status; in response to receiving, at the target, a second command of a subset of the set of commands from the initiator, providing, by the target, the second event status to the initiator.

### TECHNICAL FIELD

The invention is generally directed to storage. In particular it provides a method, system, computer program product, and computer program suitable for handling target event status in a storage system.

### BACKGROUND

Hosts communicate to underlying storage devices using standard interfaces. One such interface is Small Computer System Interface (SCSI), which is a set of command set standards for physically connecting and transferring data between computers and peripheral devices, such as disks. SCSI is available in a number of interfaces, for example, Serial Storage Architecture (SSA), 1 Gbit Fibre Channel (1 GFC), and Serial Attached SCSI (SAS). SCSI can be parallel or serial.

### SUMMARY OF INVENTION

According to the present invention there are provided a method, a system, and a computer program product according to the independent claims.

Viewed from a first aspect, the present invention provides a computer implemented method for handling target event status in a storage system, the method comprising: determining, at a target, a condition; analysing, by the target, the condition to determine a first event status associated with the condition; in response to receiving, at the target, a first command of a set of commands from an initiator, providing, by the target, the first event status to the initiator; monitoring, by the target, the condition; in response to determining that the condition is not resolved, determining, by the target, a second event status; in response to receiving, at the target, a second command of a subset of the set of commands from the initiator, providing, by the target, the second event status to the initiator.

Viewed from a first aspect, the present invention provides a system for handling target event status in a storage system, the system comprising: one or more processors, one or more computer-readable memories and one or more computer-readable storage media, a determine condition component for determining, at a target, a condition; an alert manager for analyzing, by the target, the condition to determine a first event status associated with the condition; responsive to receiving, at the target, a first command of a set of commands from an initiator, a send/receive component for providing, by the target, the first event status to the initiator; the alert manager for monitoring, by the target, the condition; responsive to determining that the condition is not resolved, a raise component for determining, by the target, a second event status; responsive to receiving, at the target, a second command of a subset of the set of commands from the initiator, the send/receive component for providing, by the target, the second event status to the initiator.

Viewed from a further aspect, the present invention provides a computer program product for, the computer program product comprising a computer readable storage medium readable by a processing circuit and storing instructions for execution by the processing circuit for performing a method for performing the steps of the invention.

Viewed from a further aspect, the present invention provides a computer program stored on a computer readable medium and loadable into the internal memory of a digital computer, comprising software code portions, when said program is run on a computer, for performing the steps of the invention.

Preferably, the present invention provides a method, system, computer program product and computer program, wherein monitoring the condition further comprises monitoring initiator operations.

Preferably, the present invention provides a method, system, computer program product and computer program, wherein the target is a SCSI target, the initiator is a SCSI initiator, and the first event status and the second event status are SCSI unit attentions.

Preferably, the present invention provides a method, system, computer program product and computer program, wherein the target is a NVMe target, the initiator is a NVMe initiator, and the first event status and the second event status are NVMe asynchronous events.

Preferably, the present invention provides a method, system, computer program product and computer program, wherein analysing the condition comprises: determining a severity; determining a first set of parameters based on the severity, the parameters comprising at least one of a list, the list comprising an initial timeliness, a frequency, and the subset of the set of commands; and determining the first event status based on the first set of the parameters.

Preferably, the present invention provides a method, system, computer program product and computer program, wherein in response to determining that the condition has not been resolved, determining the second event status at the determined frequency.

Preferably, the present invention provides a method, system, computer program product and computer program, wherein determining the first event status is performed after a time based on the initial timeliness.

Preferably, the present invention provides a method, system, computer program product and computer program, wherein determining the second event status comprises; determining a second severity; determining a second set of parameters based on the second severity; and determining the second event status based on the second set of parameters.

Preferably, the present invention provides a method, system, computer program product and computer program, further comprising: in response to determining the second event status, starting a timer; and in response to the timer reaching a timer threshold before receiving the second command, raising an error log against the initiator and reducing the frequency parameter.

Advantageously, the present invention provides a mechanism for identifying a situation that requires a unit attention, raising the unit attention and monitoring the situation. While the monitored situation still persists on the storage controller, unit attentions can be raised at a sensible frequency, and on appropriate commands until the condition is resolved.

The mechanism described here instead allows the storage controller to monitor and continue to react to a situation that needs a host change of behavior. It allows the level of reaction to be dynamically adjusted based on the impact to the storage system and host.

Advantageously, embodiments of the present invention allow a storage controller to be able to contextually understand an issue, having a feedback loop with an attached host until the issue is resolved.

Advantageously, embodiments monitor a situation and periodically re-raise a unit attention, or raise a new unit attention in response to that situation. The storage controller raises unit attentions in an appropriate manner according to the context and severity of the issue. These embodiments provide a more appropriate behaviour over existing approaches to handling unit attentions.

Advantageously, embodiments overcome problems by reminding the host that it needs to reevaluate the state by identifying a cause of the unit attention, change state etc.

Advantageously, the target keeps track of initiator behaviour and whether the next initiator commands received are sufficient enough for the target to be satisfied that the initiator has noticed the change in state. The initiator will need to send the right sequence of commands in order to be able to satisfy the target.

Advantageously, the invention can be implemented on any target device.

### BRIEF DESCRIPTION OF THE DRAWINGS

The present invention will now be described, by way of example only, with reference to preferred embodiments, as illustrated in the following figures:

FIG. 1 depicts a computing environment 100, according to an embodiment of the present invention;

FIG. 2 depicts a high-level exemplary schematic flow diagram 200 depicting operation methods steps for managing SCSI Unit Attentions from a target device, according to a preferred embodiment of the present invention;

FIG. 3 depicts an exemplary schematic flow diagram 300 depicting operation methods steps for analysing an identified condition, according to a preferred embodiment of the present invention;

FIG. 4 depicts an exemplary schematic flow diagram 400 depicting operation methods steps for monitoring a condition, according to a preferred embodiment of the present invention;

FIG. 5 depicts an exemplary schematic flow diagram 500 depicting operation methods steps for responding to a host, according to a preferred embodiment of the present invention;

FIG. 6 depicts an exemplary schematic flow diagram 600 depicting operation methods steps for monitoring a host, according to a preferred embodiment of the present invention;

FIG. 7 depicts an exemplary schematic diagram 700 of software elements, according to a preferred embodiment of the present invention; and

FIG. 8 depicts a high-level exemplary schematic diagram depicting a computer system 800, according to a preferred embodiment of the present invention.

### DETAILED DESCRIPTION

As described previously, hosts communicate to underlying storage devices using standard interfaces. One such interface is SCSI, which is a set of command set standards for physically connecting and transferring data between computers and peripheral devices, such as disks. SCSI is available in a number of interfaces, for example, SSA, 1 GFC, and SAS. SCSI can be parallel or serial.

Another such interface is Non-Volatile Memory Express (NVMe).

SCSI is command based. A host submits commands to a storage device (more specifically logical unit (LU)) using a SCSI subsystem connecting the host to an end device. The device returns responses to these commands.

An initiator is a device which submits SCSI commands, and a target is a device which receives them. Although a host will usually be the initiator, many SCSI host bus adapters (HBAs) can be configured in target mode, meaning that the host acts as a target not an initiator.

SCSI consists of a base command set which all SCSI devices must support, and device specific command sets for different types of devices. For example, the SCSI Block Commands command set is implemented by hard disk drives, solid-state drives (SSDs), and floppy drives.

When a command completes, a status byte is returned. A LU also maintains sense data, which is a binary structure describing the current status of the device, generally reflecting any errors which occurred after the execution of the last command. Typically, in the case of a check condition, such sense data is returned to an initiator with the status byte.

Within the sense data, there is a 4-bit sense key, the one-byte additional status code (ASC) and the one-byte additional status code qualifier (ASCQ). The sense key provides very coarse information on the kind of error; the ASC is much more detailed and is then further qualified by the ASCQ, the meaning of which depends on the ASC.

One sense key is ‘unit attention’, which signifies, for example, that an attention condition has been created, or has undergone a significant change in status. This can include events like a device reset, a change in power state, or other conditions that may affect the normal operation of the device. A unit attention condition signifies to the initiator that an event has occurred which should interrupt normal command processing. A SCSI target raises a unit attention when it needs to notify the SCSI initiator of a particular condition or behavior change.

Here within, the term “condition” will refer to a condition that can result in a status alert. Also, here within, the term “unit attention” will be used for a status alert in the context of SCSI, and the term ‘asynchronous event’ will be used for a status alert in the context of NVMe.

When a unit attention condition occurs, any command other than INQUIRY, REPORT LUNS or REQUEST SENSE will fail with a status code of CHECK CONDITION and a sense key of UNIT ATTENTION until the unit attention condition is cleared.

Unit attention conditions can generally be cleared by issuing REQUEST SENSE; an initiator may then (if desired) resubmit whatever commands it was previously trying to execute.

Typically, on a storage controller, a unit attention will be flagged on a login: the next SCSI command that is allowed to be returned with a unit attention is received on the login, that next SCSI command will be failed with a check condition and KCQ that describes the unit attention response.

Actions such as creating a volume host mapping or changing the preferred access characteristics require a unit attention to notify the host. Once the unit attention has been sent, the requirement is cleared regardless of whether the host receives the unit attention.

A host will send Input/Output (I/O) SCSI commands, as well as regular polling SCSI commands that are outside of the I/O stream. These polling commands allow the host to understand the current state of the available paths to the storage controller.

Thus, a unit attention signal is a signal sent out by a SCSI target to inform a host of the SCSI target's current status. A SCSI target can issue a unit attention signal if it undergoes a change in status that attached hosts need to be aware of. For example, a SCSI target may communicate to the hosts that it has an error or has been rebooted.

In some solutions, once a unit attention has been reported, it is cleared in the storage controller. However, the unit attention could be dropped by the network and lost forever. In some cases, recovering from a missed unit attention requires user intervention and may affect availability.

It is possible for SCSI unit attentions to get ignored by hosts/initiators so SCSI targets/storage controller updates of the state of the device could be left unseen by the host and therefore affect the user experience.

Examples of reasons why a host may never appropriately respond and as such be classified as a misbehaving host include but are not limited to: misconfiguration, the level of the software, bugs in the host software or host software drivers, multipathing driver confusion, network issues between the host and storage.

In the alternative Non-Volatile Memory Express (NVMe) specification, an ‘asynchronous event’ is a comparable mechanism to a SCSI Unit Attention. The difference is that the host should always have an ‘asynchronous event request’ outstanding, so the host is able to respond in a timelier manner to an asynchronous event than to a unit attention which has to wait for the next host command. According to the NVMe Specification, asynchronous events are used to notify host software of status, error, and health information as these events occur. To enable asynchronous events to be reported by the controller, host software needs to submit one or more ‘Asynchronous Event Request’ commands to the storage controller. The controller specifies an event to the host by completing an Asynchronous Event Request command. Host software should expect that the controller may not execute the command immediately; the command should be completed when there is an event to be reported.

Therefore, there is a need in the art to address the aforementioned problem.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

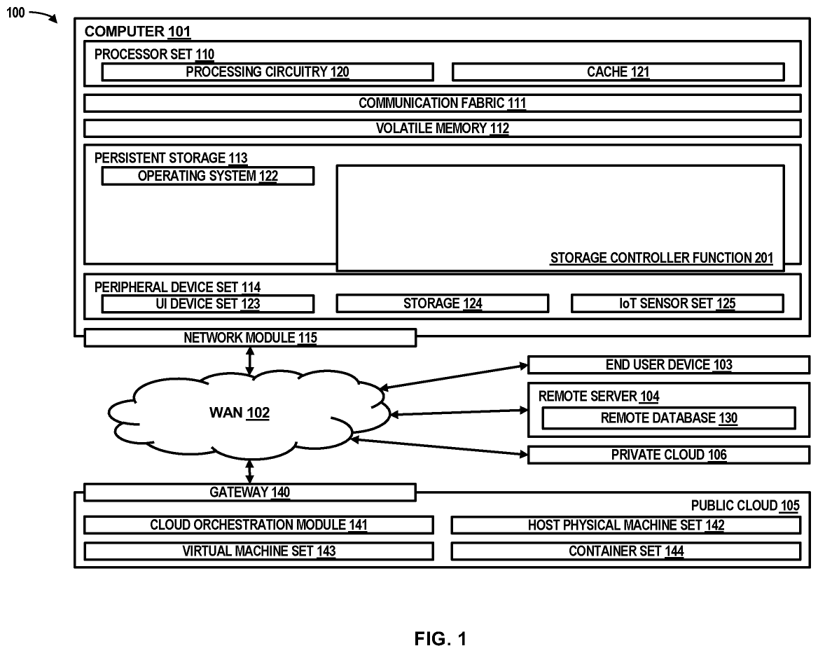

FIG. 1 depicts a computing environment 100. Computing environment 100 contains an example of an environment for the execution of at least some of the computer code involved in performing the inventive methods, such as software functionality 201 for an improved storage controller 812. In addition to block 201, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 201, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 201 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 201 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard disk, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A logical unit number (LUN) is a unique identifier for identifying a collection of physical or logical storage. A LUN can reference a single disk, a partition of disks, or an entire RAID array. Logical block addressing (LBA) is a method for specifying a location of blocks of data on storage devices.

In the storage subsystems of IBM® DS8000® series, IBM Storwize®, and IBM FlashSystem, the SAS protocol is used for the internal disks. The storage subsystems have controllers that provide the required hardware adapters for host connectivity to the subsystem. RAID adapters are used to create a virtual disk or logical unit number (LUN) that is configured in one of the supported RAID levels with multiple SAS hard disks based on the level of RAID used. Various levels of RAID of available to configure internal SAS HDDs or SDDs. IBM, DS8000, Storwize, FlashCopy, and Spectrum Virtualize are trademarks of International Business Machines Corporation, registered in many jurisdictions worldwide.

The skilled person would understand that there are other command sets and interfaces. Another example is NVM Express (NVMe) or Non-Volatile Memory Host Controller Interface Specification (NVMHCIS), which is an interface specification for accessing a computer's non-volatile storage media usually attached via PCI Express (PCIe) bus. Other storage interface standards, such as Serial ATA (SATA) or Serial Attached SCSI (SAS), have their own mechanisms for handling events or conditions that require attention. For example, SATA supports error and status registers that can indicate various conditions. NVMe is a protocol designed for modern storage devices like SSDs. It has its own error and status reporting mechanisms. Events that may require attention are typically reported through asynchronous events, error information log entries, or status codes in response to specific commands. USB devices, including storage devices, use different mechanisms for reporting status and handling events. USB Mass Storage devices, for instance, may use the Bulk-Only Transport (BOT) protocol, and error conditions can be reported through the appropriate command status wrappers. While the specific mechanisms and terminology may differ between storage interfaces, each typically has its own way of handling and reporting events or conditions that require attention, and there may not be a direct equivalent to SCSI unit attention in all cases.

In a preferred embodiment the invention is described in the context of a host communicating to a storage controller using the SCSI protocol. In a SCSI network, a host 806 issues commands to a storage controller 812 acting as a target. Although the storage controller 812 passes on these commands to underlying storage devices 808, 816, the host 806 is not aware of these devices 808, 816. Further, the devices 808, 816 receive the commands from the storage controller 812 as if the storage controller 812 is an initiator. In a like manner underlying storage devices 808, 816 are not aware of any upstream hosts 806, but only the storage controller 812.

The skilled person would understand that in NVMe, an ‘asynchronous event’ is a comparable mechanism to a SCSI Unit Attention. The difference is that the host should always have an ‘asynchronous event request’ outstanding, so the host is able to respond in a timelier manner to an asynchronous event than to a unit attention which has to wait for the next host command.

The skilled person would understand that a SCSI Unit Attention (UA), and a NVMe asynchronous event are examples of event status.

In a preferred embodiment, the invention will be described in the context of a host acting as a SCSI initiator, and a storage controller acting as a SCSI target. The skilled person would understand that a storage controller can act as a SCSI initiator for underlying storage devices acting as SCSI targets. Indeed, there can be different layers of virtualisation acting as SCSI targets to SCSI initiators at a higher layer. In the following, the term “host” will be used to describe a SCSI initiator, and “storage controller” will be used to describe a SCSI target.

In a multi-host system, a number of hosts are attached to a storage controller. In this configuration it is important to manage unit attentions to ensure that all attached hosts take appropriate actions. In some solutions, a unit attention could be presented to a storage controller, and issued to only a first host, leaving a second host with no knowledge of a device error event. However, this can lead to incorrect behavior by the second host with a risk of performance degradation or even data corruption.

Returning to a preferred embodiment of a SCSI interface, Key Code Qualifier (KCQ) is an error-code returned by a SCSI device. When a SCSI target device returns a check condition, the initiator typically issues a SCSI Request Sense command. The target device responds with SCSI sense data called Key Code Qualifier or KCQ. The KCQ is a 20 bit field, which comprises three fields describing details about the error:
K-sense key-4 bits, (byte 2 of Fixed sense data format)
C-additional sense code (ASC)-8 bits, (byte 12 of Fixed sense data format)
Q-additional sense code qualifier (ASCQ)-8 bits, (byte 13 of Fixed sense data format)
The initiator can take action based on just the K field which indicates if the error is minor or major. Different device types have different KCQ value definitions.

For example, 0110 00011101 00000000 (06 29 00) signifies: Unit Attention (06), Power On, Reset, or Bus Device Reset Occurred (29 00).

SCSI Unit Attentions can be generated for various reasons on the IBM Spectrum Virtualize system. These include:
1. Device Status Change, for example, from online to offline.
2. Configuration Changes, for example, addition of storage devices
3. Error Conditions.
4. Firmware Updates.

TABLE 1
examples of ASC, and ASCQ summary
for Sense Key 6 (Unit Attention)

| ASC ASCQ | Description |
|---|---|
| 00 02 | End-of-partition/medium detected, |
| | early warning |
| 28 00 | Not ready to ready transition, medium |
| | might have changed |
| 29 00 | Power-on, reset, or bus device reset |
| | occurred |
| 2A 01 | Mode parameters changed |
| 2A 02 | Log parameters changed |
| 2F 00 | Commands cleared by another initiator |
| 30 00 | Incompatible medium Installed |
| 3F 01 | Microcode has been changed |

Using an example of IBM Storage FlashSystem 7300, the following terms can be used.

A host system is a computer that is connected to the system through supported connection protocols. The term application server can be used to denote a host that is attached to the system and runs applications. A host cluster is a group of logical host objects that can be managed together. For example, a volume mapping can be created that is shared by every host in the host cluster. The system uses internal protocols to manage access to the volumes and ensure consistency of the data. Host objects that represent hosts can be grouped in a host cluster and share access to volumes. A host can only be in one host cluster at a time. New volumes can also be mapped to a host cluster, which simultaneously maps that volume to all hosts that are defined in the host cluster. Host mapping is the process of controlling which hosts or host clusters have access to specific volumes within the system.

An external storage system, or storage controller, is a device that coordinates and controls the operation of one or more disk drives. A storage system synchronizes the operation of the drives with the operation of the system as a whole.

A system can be an active-active dual controller system. Active-active is a term that describes the I/O processing mechanisms in a storage controller. A system can comprise a pair of controller nodes. An active-active controller pair processes I/O for a specific volume through either node. The opposite mechanism would be an active-passive controller system. In active-passive, only one node processes I/O for a specific volume. If a passive node receives I/O, it forwards the I/O to the active node to process. A volume is a logical disk that the system presents to attached hosts. A volume group is a container for managing a set of related volumes as a single object. The volume group provides consistency across all volumes in the group.

Storage Drives are used to create arrays that provide capacity for pools and volumes. Enclosures are rack-mounted hardware that contain several components of the system. Enclosures can be used to extend the capacity of the system. The pair of nodes within a single enclosure is known as an input/output (I/O) group. When a write operation is performed to a volume, the node that processes the I/O duplicates the data onto the partner node that is in the I/O group. After the data is protected on the partner node, the write operation to the host application is completed. The data is physically written to the disk later.

A managed disk (MDisk) is a logical unit of physical storage. MDisks are not visible to host systems. MDisks are either arrays (RAID) from internal storage or volumes from external storage system.

A fabric refers collectively to the equipment and configuration that implements a network. A network fabric describes the network topology in which components pass data to each other through interconnecting switches. A storage area network (SAN) is a pool of storage systems that are interconnected to the servers in an enterprise. In general, a pool or storage pool is an allocated amount of capacity that jointly contains all of the data for a specified set of volumes.

The system connects to host systems and storage devices on the SAN or the Ethernet network through switches. Switches from different vendors can be used together in the system configuration.

For data protection many of the hardware components within storage system are duplicated to provide redundancy. If one component of a pair fails, operations are “failed over” to the other component of the pair.

Unit Attention. A state that a logical unit maintains while it has asynchronous status information to report to the SCSI initiator ports.

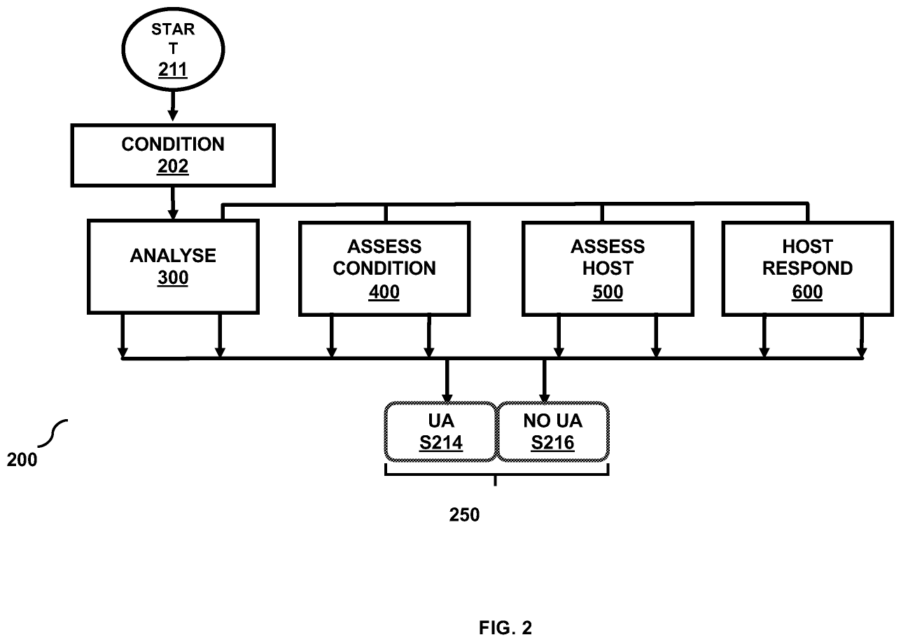

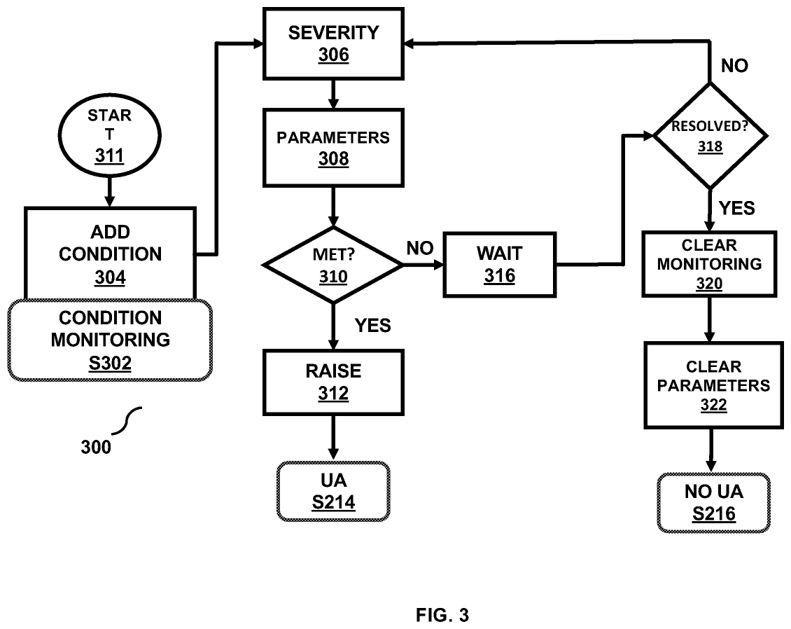

FIG. 2, which should be read in conjunction with FIGS. 3 to 8, depicts a high-level exemplary schematic flow diagram 200 depicting operation methods steps for managing SCSI Unit Attentions from a SCSI target device, according to a preferred embodiment of the present invention. Hereinto, states are depicted by a prefix of “S”, for example, state S214 depicts a state 250 of a unit attention being raised.

FIG. 3 depicts an exemplary schematic flow diagram 300 depicting operation methods steps for analysing an identified condition S735, according to a preferred embodiment of the present invention;

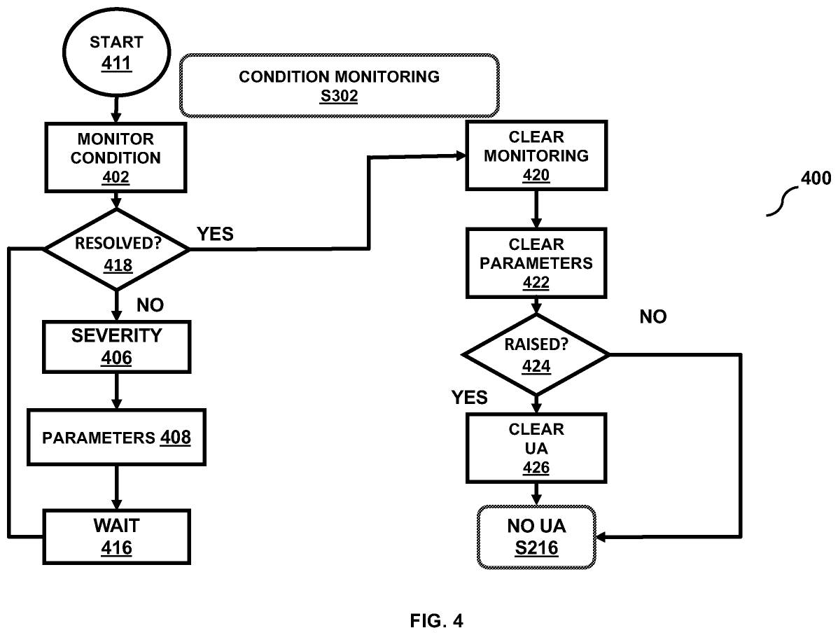

FIG. 4 depicts an exemplary schematic flow diagram 400 depicting operation methods steps for assessing a condition S735, according to a preferred embodiment of the present invention;

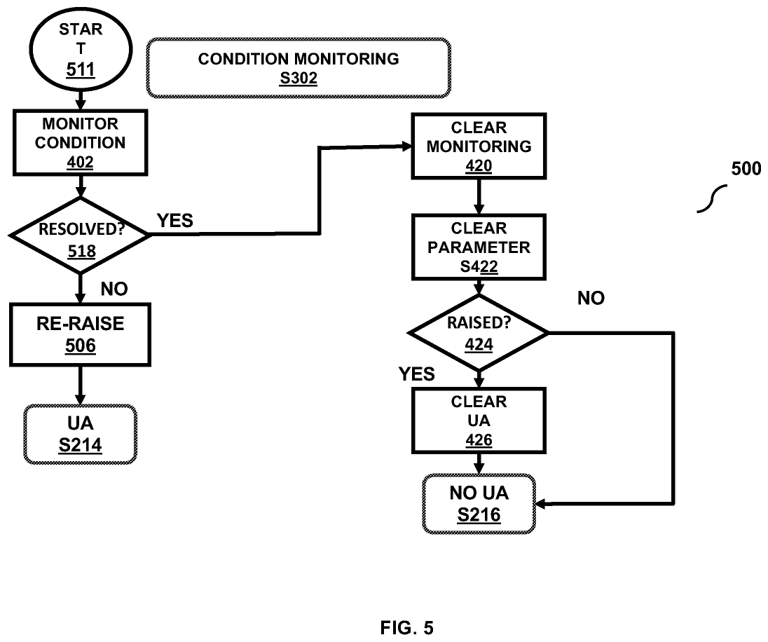

FIG. 5 depicts an exemplary schematic flow diagram 500 depicting operation methods steps for assessing a host 806, according to a preferred embodiment of the present invention;

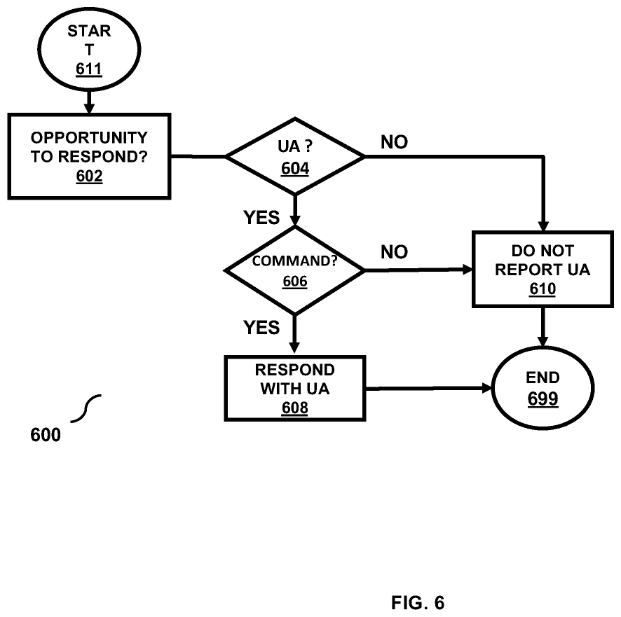

FIG. 6 depicts an exemplary schematic flow diagram 600 depicting operation methods steps for responding to a host 806, according to a preferred embodiment of the present invention;

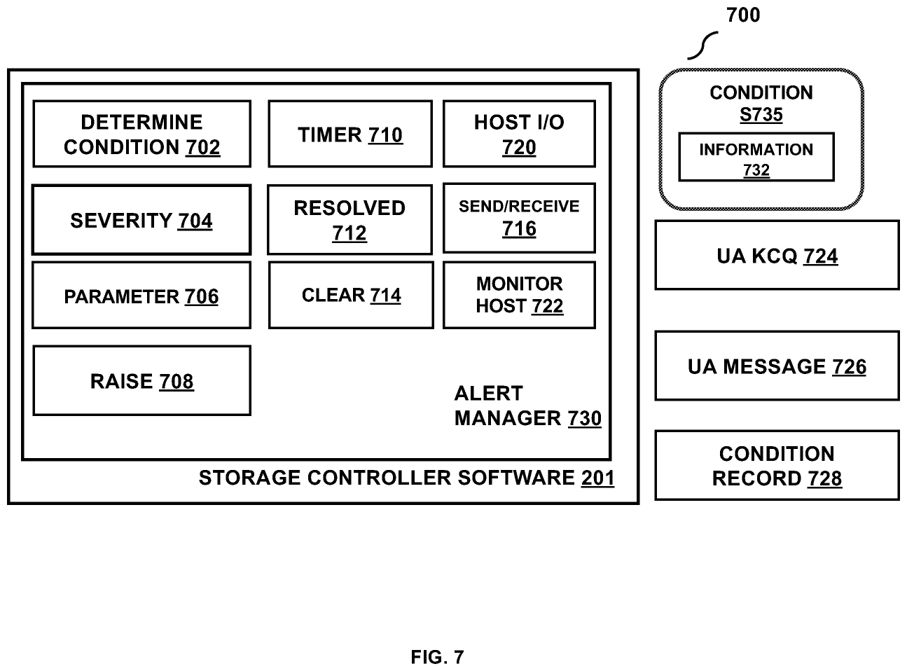

FIG. 7 depicts an exemplary schematic diagram 700 of software elements, according to a preferred embodiment of the present invention; and

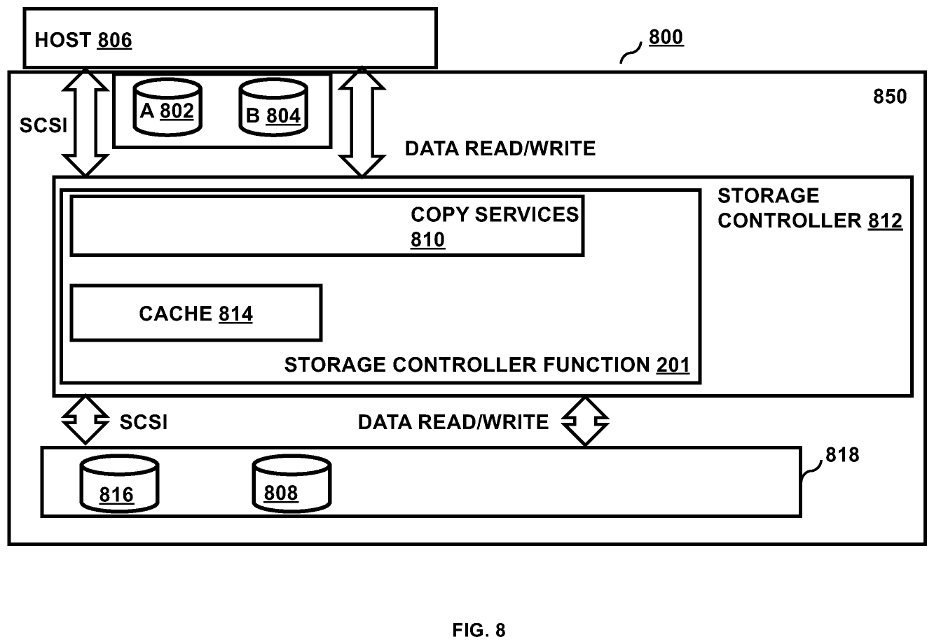

FIG. 8 depicts a high-level exemplary schematic diagram depicting a primary computer system 800, according to a preferred embodiment of the present invention. FIG. 8 depicts a host 805, and a storage system 850. The storage system 850 comprises a storage controller 812, and a storage drive disk enclosure 818. The storage controller 812 also comprises a stack of components, for example a copy services component 810, and a cache component 814. The enclosure 818 comprises two underlying storage devices 816, 808. Commands are passed between the host 806, storage controller 812 and drive enclosure 818 using SCSI commands. If a cache 814 is available, data is written to the cache 814 and destaged to the storage devices 816, 808 according to a cache algorithm. For reads, data is first read from the cache 814, and only if not present (known as a cache miss), the data is read from the devices. Data is read and written across the depicted interfaces. For the purposes of illustration of the present invention, reads and writes to storage devices 816, 808 are considered a being equivalent to reads and writes to the corresponding cache layers as well. Underlying storage devices are presented to the host 806 as logical storage volumes A 802, and B 804 in a storage pool, because, for example, the actual underlying storage devices in the storage enclosure 818 may be in reality devices of a RAID array. In a High Availability (HA) system, devices are replicated with, for example, a second host 806′ (not shown), a second storage controller 812′ (not shown), and a second storage enclosure 818′ (not shown). Copy services 810 can copy data stored on the underlying storage devices 816, 808, to underlying storage devices 816′, 808′ (neither shown) on the second storage enclosure 818′ managed by the second storage controller 812′. Storage controller 812, 812′ comprise hardware/software adapters for interfacing to hosts 806, 806′, and underlying storage devices 816, 808, 816′, 808′. In the case of HA storage controllers 812, 812′ with two adapters, such adapters are often referred to as primary and secondary.

Arrows depicted in the figures represent SCSI command and also read/write data paths.

The method comprises analysing, by a storage controller 201 acting as a SCSI target, a received condition S735 to determine whether to raise a unit attention. The condition S735 is monitored with the aim of deciding whether the condition S735 is still present. The unit attention is sent to a host (SCSI initiator) 806 on a command from the host 806. The condition S735 and storage context determine the severity. The required initial timeliness, frequency of repeated unit attentions, and which commands should be used to raise the unit attention is dependent on the severity. While the condition S735 has not been resolved, the unit attention is raised at the required frequency, using the severity to determine which commands should be affected. Once the condition S735 has been resolved, the repeated unit attention is cleared.

Referring to FIG. 2, the method starts are step 211. The method is managed by an alert manager 730 of the storage controller software 201. At step 202, a determine condition component 702 of the alert manager 730 receives information 732 to identify a condition S735. The condition S735 refers to a state, comprising asynchronous status information 732 that is of interest to hosts 806. Examples of conditions S735 are: creation of a volume host mapping; changing the preferred access characteristics etc.

FIG. 2 depicts four main methods of the overall method 200: an analyze method 300 for analysing the condition S735; an assess condition method 400 for monitoring 400 the condition S735; an assess host method 500 for monitoring the host 806; and a host respond method 600 for responding to the host 806. Each of the four methods can result in a state 250 of ‘UA’ S214, or ‘No UA’ S216. In a state 250 of ‘UA’ S214 a structure UA KCQ 724 comprising (Sense Key 6, ASC, and ASCQ) is populated. In a state 250 of ‘No UA’ 216, structure UA KCQ 724 is cleared.

In practice the four methods act in parallel. Method 300 sets up the condition monitoring state S302. Both methods 400 and 500 monitor the condition S735. Method 400 monitors and assesses the condition S735 to dynamically change parameters, depending on the severity of the condition S735. The severity of the condition S735 can change, because of external actions, such as host behavior, or internal configuration state, for example, volumes being taken offline. Method 500 also monitors the condition S735, but with a view to reassessing whether a unit attention needs to be re-raised based on the monitored condition still being present/active, possibly based on subsequent host behaviour.

FIG. 3 depicts an exemplary schematic flow diagram 300 depicting operation methods steps for the analyse method for analysing an identified condition S735, according to a preferred embodiment of the present invention. This method 300 uses the condition S735 to initially create a unit attention. In this method 300, the storage controller 201 makes a decision that a unit attention is required based on the condition S735.

The method starts at step 311. A state enters that of Condition Monitoring S302. At step 304 the alert manager 730 adds information 732 about the condition S735 to a condition record 728. The information 732 in the condition record 728 will be used by alert manager component 730 of the storage controller software 201 as the method 200 is processed. The condition record 728 is typically a software structure, such as a register. The skilled person would understand that the condition record 728 could also be stored in a hardware register.

At step 306 a severity component 704 determines a severity of the condition S735. The condition S735 and storage context determine the severity. In an embodiment severity is defined based on the condition S735 observed and the resultant impact on the host 806 and storage controller 812. Severity can be measured in integer values, for example, 1-10, but the skilled person would understand that other scale types could be used. Therefore, an example of a critical severity (for example severity 10) is a loss of access. An example of a dynamic severity is an impact to performance, ranging from no noticeable impact (for example, severity 1) to high latencies and resource constraints causing application slowness or outages (for example, severity 10). Severity is defined based on the condition S735 observed and the resultant impact on the host 806 and storage controller 812.

At step 308, a parameter component 706, determines parameters for a resultant unit attention, such as timeliness criteria, frequency of repeated unit attentions and which host commands can be responded to with a unit attention, based on the severity. Severity and these parameters are added to the condition record 728. In some solutions a unit attention is raised as soon as an event occurs. A timeliness parameter allows a timer 710 to be set to allow for a lag between the condition S735 being identified and the unit attention being set. Allowing a ‘timeliness’ criteria for some conditions S735 means that a host does not need to be informed immediately about a condition S735. For example, a stream of host I/O 720 may be allowed to complete before reporting a configuration change. ‘Timeliness’ in this context means that the unit attention should be reported by the time this time interval has elapsed, but could be reported sooner if conditions S735 make that appropriate. Alternatively, a condition S735 may occur that might have resolved itself before any need of reporting it to the host 806. In this case, ‘timeliness’ is a delay before first raising the unit attention—the unit attention will not be reported to the host 806 until the time interval has elapsed.

The skilled person would understand that parameters set for a first condition S735 may be different for a second condition S735.

Condition information 732, severity, and parameters are stored in the condition record 728.

At step 310, the parameter component 706 determines whether timeliness criteria have been met. If timeliness criteria have been met YES, then at step 312, a raise component 708 raises an appropriate unit attention in a Unit Attention (UA) KCQ record 724. The UA KCQ record 724 comprises the KCQ information about the condition S735. This produces a state 250 of ‘UA’ 214.

Returning to step 310, if timeliness criteria have not been met NO, then at step 316, a timer component 710 goes into a wait state for a period determined by the timeliness parameter. At step 318, a resolved component 712 determines whether the condition S735 has been resolved. If the condition S735 has not been resolved NO, the method returns to step 306 to again determine severity. Returning to step 318, if the condition S735 has been resolved YES, then at step 320 a clear component 714 clears the condition S735 from being monitored. At step 322 the clear component 714 clears the parameters that were determined in step 308. The state 250 is then ‘No UA’ 216.

FIG. 4 depicts an exemplary schematic flow diagram 400 depicting operation methods steps for assessing a condition S735, according to a preferred embodiment of the present invention.

Method 400, and method 500 can be started after a time period specified by the frequency parameter. The frequency parameter limits condition monitoring S302, so that unit attentions are not re-assessed and/or re-raised too rapidly. Re-raising a unit attention too rapidly could otherwise result in degraded host I/O 720 performance if a host 806 had to process unit attentions in priority over host I/O 720. Repeated unit attentions should only be raised at a frequency that is not expected to disrupt host activity. Host activity can be monitored by the alert manager 730 to adjust this frequency or prevent further repeated unit attentions from being raised. Allowing frequency to be tuned avoids the risk of continuous regular unit attentions that could hamper a host 806 if there exists a severe enough bug that prevents correct handling of unit attentions.

This method 400 depicts the method in a state of condition monitoring S302, determining if a condition S735 and any corresponding unit attentions should be cleared. The method 400 starts at step 411. At step 402 the condition S735 is monitored. Monitoring the condition S735 can comprise identifying that the condition S735 has been resolved within the storage controller, without host action being required.

At step 418, the resolved component 712 determines whether the condition S735 has been resolved. If the resolved component 712 determines that the condition S735 has been resolved YES, the method moves to step 420. At step 420 the clear component 714 clears the condition S735 from being monitored. At step 422 the clear component 714 clears the parameters that were determined in steps 308 and 408. At step 424, if the state 250 is ‘UA’ S214 then at step 426 the UA KCQ 724 is cleared, and at the state 250 moves to the state of ‘No UA’ S216. Returning to step 424, if it is determined that the unit attention is not raised then the state already in the ‘No UA’ 216 state.

The skilled person would understand that for debug and tracing purposes, all entries of structures, such as the UA KCQ 724 may be stored for later use.

Returning to step 418, if the condition S735 has not been resolved NO, the method moves to step 406 to determine severity.

At step 406 the severity component 704 re-determines a severity of the condition S735. The condition S735 and storage context again determine the severity.

At step 408, the parameter component 706, determines parameters for the resultant unit attention, such as timeliness criteria, frequency of repeated unit attentions and which host commands can be responded to with the unit attention, based on the severity. If necessary, the condition record 728 is appended to the previous parameters, or amended with the new parameters.

At step 416, the timer component 710 goes into a wait state for a period determined by the timeliness parameter, before returning to step 418. Loop 418-406-408-416-418 is very similar to that of 318-306-308-316-318, except that step 310 is skipped in method 400, as a Unit Attention is already raised.

FIG. 5 depicts an exemplary schematic flow diagram 500 depicting operation methods steps for assessing a host 806, according to a preferred embodiment of the present invention. This method uses an existing condition S735 to re-raise a unit attention.

This method 500 also depicts the method in a state of Condition Monitoring S302, determining if a condition S735 should be re-raised. The method 500 starts at step 511. At step 402 the condition S735 is monitored as described in relation to FIG. 4.

At step 518, the resolved component 712 determines whether the condition S735 has been resolved.

At step 518, if the resolved component 712 determines that the condition S735 has been resolved YES, the method follows the same steps as described in relation to FIG. 4. At step 420 the clear component 714 clears the condition S735 from being monitored. At step 422 the clear component 714 clears the parameters that were determined in steps 308 and 408. At step 424, if the state 250 is ‘UA’ S214 then step 426 the UA KCQ 724 is cleared, and at the state 250 moves to the ‘No UA’ S216 state. Returning to step 424, if it is determined that the unit attention is not raised then the state already in the ‘No UA’ S216 state.

Returning to step 518, if the condition S735 has not been resolved NO, the method moves to step 506. Step 518 can comprise determining whether the host 806 has adequately dealt with the condition S735 in view of having received a unit attention from the storage controller 201. The method of providing a unit attention to the host 806 is described in relation to FIG. 6 below. At step 506 the unit attention is re-raised, resulting in a state 250 of ‘UA’ S214. It should be understood that the term “re-raise” can also describe when a second unit attention is raised as a result of the host 806 not dealing with a first unit attention correctly. The first unit attention and the second unit attention can be identical. In an alternative embodiment, the first unit attention and the second unit attention are different.

Monitoring the condition S735 can also comprise determining whether the host 806 has dealt with an existing unit attention. An analysis of host behaviour would be one way for such determination. Monitoring can comprise a monitor host component 722 of the alert manager 730 monitoring host commands or monitoring host I/O 720 patterns. If a unit attention has been dealt with correctly by the host 806, the alert manager 730 could expect particular host commands in response. If those particular host commands are received, the unit attention does not need to be re-raised. However, if not the host 806 can be proactively prompted by re-raising the unit attention to send to the host 806 on the next host command. If a unit attention has been dealt with correctly by the host 806, the alert manager 730 could also expect particular I/O 720 patterns, for example, host I/O 720 to primary paths. If those particular host I/O 720 patterns are determined, the unit attention does not need to be re-raised. However, if not the host 806 can be proactively prompted by re-raising the unit attention to send to the host 806 on the next host command.

Determining that a condition has been resolved at steps 418 and 518 may also comprise monitoring an expected sequence of host 806/storage controller 201 interactions.

For example, a primary path to underlying storage devices 816, 808, is changed and is raised as a condition S735. The storage controller sends a unit attention to the host 806 in response to a host command. However, the host continues to direct host I/O 720 at a path that had previously been the primary path. At step 518 the resolved component 712 determines that the condition S735 has not been dealt with correctly. At step 506, the alert manager 730 re-raises the unit attention. In parallel, the steps of method 400 may also reassess 406 severity, and reassess 408 parameters, because the behaviour of the host can affect the severity and resultant parameters.

FIG. 6 depicts an exemplary schematic flow diagram 600 depicting operation methods steps for responding to a host 806, according to a preferred embodiment of the present invention. This method 600 uses an event monitoring condition S735 to determine if a created unit attention should be reported to the host 806. The method starts at step 611. At step 602, the alert manager 730 has an opportunity to respond to the host 806. The send/receive component 716 receives a command from the host 806, the command identified as being appropriate for the device server to terminate with a CHECK CONDITION and to report the condition S735. If a command other than INQUIRY, REPORT LUNS, REQUEST SENSE, or NOTIFY DATA TRANSFER DEVICE enters the enabled command state while a condition S735 exists for the SCSI initiator port associated with the I_T nexus on which the command was received, the device server shall terminate the command with a CHECK CONDITION status. The I_T nexus is a relationship between a SCSI Initiator Port and a SCSI Target Port.

At step 604 the method 600 determines whether a unit attention exists. If a state 250 of ‘No UA’ S216 exists, at step 610 no unit attention is reported, and at step 699 the method 600 ends. Returning to step 604, if a state 250 of ‘UA’ S214 exists, the method moves to step 606. At step 606 the alert manager 730 determines whether the command received is one of the commands that will trigger a unit attention being reported. At step 608 the device server sends the sense data in UA KCQ 24 in a UA Message 726 to report a condition S735 for the SCSI initiator port of the host 806 that sent the command on the I_T nexus.

The skilled person would understand that for one condition S735, a unit attention may be raised against each I_T nexus.

After a condition S735 initially results in a state 250 of ‘UA’ S214, at step 606 the list of commands that will trigger a UA Message 726 comprises the full set of commands as specified in the SCSI Architecture manuals and documents. However, for re-raised unit attentions, the list of commands that will trigger a UA Message 726 may be a reduced list as identified in step 308/step 408.

Embodiments of the invention will be further described with use of examples.

### Example 1

A host 806 ignoring a change of preferred path (Asymmetric Access State Changed unit attention) will impact the I/O resources of the storage devices 808, 816. Host I/O 720 may require forwarding from the initial target (e.g., storage controller 812 acting as target) to other targets 812′.

For example, a volume 802 may be cached in one node of a storage controller 812, but not cached in the other. Host I/O 720 directed to the first node may see higher performance than host I/O 720 directed to the other node, as this would need to be forwarded between nodes within the storage controller 812. If the caching node changes, the storage controller can indicate this to the host by setting the AAS of paths to the caching node as Active/Optimized, and paths to the non-caching node as Active/Non-Optimized.

An initial unit attention is raised quickly in order to immediately notify the host 806.

The device server establishes a unit attention according to method 300 for the SCSI initiator port associated with every I_T nexus, with the additional sense code set to ASYMMETRIC ACCESS STATE CHANGED.

Sense key: 6h UNIT ATTENTION (Indicates that a unit attention
has been established (e.g., the removable medium may
have been changed, a logical unit reset occurred, etc.)
Additional Sense Code: 2Ah
Additional Sense Code Qualifier: 06h
Description: ASYMMETRIC ACCESS STATE CHANGED

Monitoring commences against the set of associated initiators (host) to indicate a REPORT TARGET PORT GROUPS command (operation code A3 h with service action 0 Ah) is now expected from initiator ports associated with that host 806. If after some period of time other command are received from the host and a REPORT TARGET PORT GROUPS has not been seen, the ASYMMETRIC ACCESS STATE CHANGED unit attention would be re-raised to prompt the host to send the REPORT TARGET PORT GROUPS command.

Further, when a REPORT TARGET PORT GROUPS command has been received from the host 806, the alert manager 730 responds with parameter data that includes target port group descriptors that include an ASYMMETRIC ACCESS STATE (AAS) field as well as target port descriptors for the target ports in that target port group (see ‘Target port group descriptor format’ in SCSI Specification. However, if the host 806 does not successfully receive or act on this response, commands from that host can continue to be monitored until further I/O command such as READs and WRITEs have been received from that host 806.

While the storage controller 812, 812′ observes in step 518 that the host path usage does not match the storage path preference, the alert manager 730 will repeat the unit attention. For example, if these I/O commands continue to be received via I_T nexuses whose target ports were in a port group reported as having an AAS other than Active/optimized (for instance, an AAS of Active/non-optimized or Standby), then the host is continuing to use a non-preferred I_T nexus. The ASYMMETRIC ACCESS STATE CHANGED unit attention on this I_T nexus can be re-raised. If these I/O commands are instead received via the I_T nexuses whose target ports were in a port group reported as having an Active/optimized AAS, then the host 806 has actioned the alert manager 730 response to the REPORT TARGET PORT GROUPS command and condition monitoring S302 can be cleared.

A host 806 using non-preferred paths will not result in a loss of access, but it could result in an impact to performance. The severity of this performance impact would affect the frequency of the repeating unit attention, and which commands are used to raise the unit attentions.

If the performance is not noticeably impacted then the frequency can be reduced and the commands used could be the host polling commands rather than affecting the current I/O command stream. In the event of performance being impacted, the frequency of the repeated unit attention would be increased at step 406 and it would be permitted to interrupt I/O commands.

### End of Example 1

### Example 2

A logical unit (LU) inventory changes. The device server establishes a unit attention according to method 300 for the SCSI initiator port associated with every I_T nexus, with the additional sense code set to REPORTED LUNS DATA HAS CHANGED.

Sense key: 6h UNIT ATTENTION (Indicates that a unit attention
has been established (e.g., the removable medium may
have been changed, a logical unit reset occurred, etc.)
Additional Sense Code: 3Fh
Additional Sense Code Qualifier: 0Eh
Description: REPORTED LUNS DATA HAS CHANGED

Condition Monitoring S302, methods 400 and 500 begin at steps 411 and 511 against the host 806 or set of associated hosts 806 to indicate that a REPORT LUNS command (operation code A0 h) is now expected from a SCSI initiator port associated with that host 806. If, after some period of time, steps 402, 418 and 518 determine that other commands are received from the host 806 and a REPORT LUNS has not been seen. As a result, the REPORTED LUNS DATA HAS CHANGED unit attention would be re-raised in step 506 to prompt the host 806 to send the REPORT LUNS command.

Further, when a REPORT LUNS command has been received from the host 806, the storage controller 201 responds with REPORT LUNS parameter data that includes data about the newly available logical unit. It would be expected that the host 806 initiates discovery of the new logical unit.

However, if the host 806 does not successfully react in this way, monitoring at step 402 can continue from that host until discovery commands like INQUIRY have been sent to the new logical unit from that host. If no INQUIRY command is received to the new logical unit within a monitored period of time, at step 506, a REPORTED LUNS DATA HAS CHANGED unit attention can be re-raised. This illustrates an example when steps 418 and 518 monitor an expected sequence of host 806/storage controller 201 interactions.

### End of Example 2

### Example 3

A host 806 ignoring a “LUN inventory changed” during mapping of new volumes to that host 806, will not affect the ongoing workload for applications that are not using the new volumes, nor will it impact the storage controller 812 resources. However, a host 806 not becoming aware of the new volumes can impact the deployment of a new application.

The low severity assessed at step 306 of this issue would mean that an initial unit attention would be raised quickly at step 312 to notify the host 806 of the new volumes. In the event that active polling of the new volumes is not observed at steps 402 and 502, a unit attention corresponding to the “LUN inventory changed” with a low frequency and only on host polling commands, as determined at step 408 is raised at step 506. This example illustrates how methods 400 and 500 operate in parallel to re-raise a unit attention at step 506, and to assess the parameters associated with the condition S735, at step 408.

### End of Example 3

### Example 4

Embodiments allow the ability to remove a unit attention that is no longer required. If the condition is deemed resolved at step 418, 518, before the initial unit attention has been reported to the host 806, the initial unit attention can be cleared at step 426 without any need to raise the repeated unit attention. Being able to clear the initial unit attention is an improvement over the other solutions, as e.g., if the preferred path has reverted back to its original state before the initial Asymmetric Access State Changed unit attention has been reported to that host 806, the host 806 does not need to know about the transient change in preferred paths—the current state is again the same as the state that the host 806 knows about, so the unit attention is no longer required.

### End of Example 4

In an alternative embodiment (not depicted), to prevent the repeated reporting of unit attentions to a host 806 that will never respond appropriately, a timeout period can be set, which can be, for example, dependent on condition severity. A timeout threshold, should the host 806 not respond appropriately to unit attentions within the timeout threshold, will raise an error log entry against the host 806. The frequency of repeated unit attentions to a background level can be returned at step 406, or the Condition Monitoring S302 can be left, which gives up attempts to provoke host behavior change by stopping the repeated unit attention.

This allows the storage controller software 201 to alert the user about the misbehaving host 806, providing error log details about what condition S735 needs to be resolved from the storage controller 201 perspective.

In an alternative embodiment a host communicates to a storage controller using the NVMe protocol. With NVMe, a status event is raised in the form of an ‘asynchronous event’. This is similar to SCSI Unit Attentions The difference is that the host 806 should always have an ‘asynchronous event request’ outstanding, so the host 806 is able to respond in a more timely manner to an asynchronous event than to a unit attention which has to wait for the next host command. Applying the present invention allows for a delay in the response to the host 806, or alternatively, repeatedly sending at step 608 the same Asynchronous Notification, as in the SCSI embodiments.

For NVMe, at step 602, the alert manager 730 has an opportunity to respond to the host 806. Here the ‘Opportunity to respond’ is the outstanding ‘asynchronous event request’ that has been received from the host 806. Details of this are to be found in sections relating to an ‘asynchronous event request’ in the NVM Express Base Specification. Specifically, the ‘asynchronous event request’ command is submitted by host software to enable the reporting of asynchronous events from the storage controller 201. This command has no timeout. The storage controller 201 posts a completion queue entry for this command when there is an asynchronous event to report to the host. This is expected to be available for an immediate response, but implementation of the invention allows for a dynamic decision on when to report an Asynchronous Notification.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein. It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above invention may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

Moreover, the same or similar reference numbers are used throughout the drawings to denote the same or similar features, elements, or structures, and thus, a detailed explanation of the same or similar features, elements, or structures will not be repeated for each of the drawings. The terms “about” or “substantially” as used herein with regard to thicknesses, widths, percentages, ranges, etc., are meant to denote being close or approximate to, but not exactly. For example, the term “about” or “substantially” as used herein implies that a small margin of error is present. Further, the terms “vertical” or “vertical direction” or “vertical height” as used herein denote a Z-direction of the Cartesian coordinates shown in the drawings, and the terms “horizontal,” or “horizontal direction,” or “lateral direction” as used herein denote an X-direction and/or Y-direction of the Cartesian coordinates shown in the drawings.

Additionally, the term “illustrative” is used herein to mean “serving as an example, instance or illustration.” Any embodiment or design described herein is intended to be “illustrative” and is not necessarily to be construed as preferred or advantageous over other embodiments or designs.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

For the avoidance of doubt, the term “comprising”, as used herein throughout the description and claims is not to be construed as meaning “consisting only of”.

What is claimed is:

1. A computer implemented method for handling target event status in a storage system, the method comprising:
determining, at a target, a condition;
analysing, by the target, the condition to determine a first event status associated with the condition;
in response to receiving, at the target, a first command of a set of commands from an initiator, providing, by the target, the first event status to the initiator;
monitoring, by the target, the condition;
in response to determining that the condition is not resolved, determining, by the target, a second event status; and
in response to receiving, at the target, a second command of a subset of the set of commands from the initiator, providing, by the target, the second event status to the initiator.

2. The method of claim 1, wherein monitoring the condition further comprises monitoring initiator operations.

3. The method of claim 1, wherein the target is a Small Computer System Interface (SCSI) target, the initiator is a SCSI initiator, and the first event status and the second event status are SCSI unit attentions.

4. The method of claim 1, wherein the target is a Non-Volatile Memory Express (NVMe) target, the initiator is a NVMe initiator, and the first event status and the second event status are NVMe asynchronous events.

5. The method of claim 1, wherein analyzing the condition comprises:
determining a severity;
determining a first set of parameters based on the severity, the parameters comprising at least one of a list, the list comprising an initial timeliness, a frequency, and the subset of the set of commands; and
determining the first event status based on the first set of the parameters.

6. The method of claim 5, wherein in response to determining that the condition has not been resolved, determining the second event status at the determined frequency.

7. The method of claim 5, wherein determining the first event status is performed after a time based on the initial timeliness.

8. The method of claim 5, wherein determining the second event status comprises;
determining a second severity;
determining a second set of parameters based on the second severity; and
determining the second event status based on the second set of parameters.

9. The method of claim 5, further comprising:
in response to determining the second event status, starting a timer; and
in response to the timer reaching a timer threshold before receiving the second command, raising an error log against the initiator, and reducing the frequency parameter.

10. A system for handling target event status in a storage system, the system comprising:
one or more processors, one or more computer-readable memories and one or more computer-readable storage media;
a determine condition component for determining, at a target, a condition;
an alert manager for analysing, by the target, the condition to determine a first event status associated with the condition;
responsive to receiving, at the target, a first command of a set of commands from an initiator, a send/receive component for providing, by the target, the first event status to the initiator;
the alert manager for monitoring, by the target, the condition;
responsive to determining that the condition is not resolved, a raise component for determining, by the target, a second event status; and
responsive to receiving, at the target, a second command of a subset of the set of commands from the initiator, the send/receive component for providing, by the target, the second event status to the initiator.

11. The system of claim 10, further comprising a monitor host component for monitoring the condition comprising monitoring initiator operations.

12. The system of claim 10, wherein the target is a Small Computer System Interface (SCSI) target, the initiator is a SCSI initiator, and the first event status and the second event status are SCSI unit attentions.

13. The system of claim 10, wherein the target is a Non-Volatile Memory Express (NVMe) target, the initiator is a NVMe initiator, and the first event status and the second event status are NVMe asynchronous events.

14. The system of claim 10, further comprising:
a severity component for determining a severity;
a parameter component for determining a first set of parameters based on the severity, the parameters comprising at least one of a list, the list comprising an initial timeliness, a frequency, and the subset of the set of commands; and
the raise component for determining the first event status based on the first set of the parameters.

15. The system of claim 14, wherein responsive to determining that the condition has not been resolved, the raise component further operable for determining the second event status at the determined frequency.

16. The system of claim 14, wherein the alert manager is further operable for determining the first event status after a time based on the initial timeliness.

17. The system of claim 14, wherein the raise component is further operable for determining the second event status by:
determining a second severity;
determining a second set of parameters based on the second severity; and
determining the second event status based on the second set of parameters.

18. The system of claim 14, further comprising:
responsive to determining the second event status, the alert manager for starting a timer; and
responsive to the timer reaching a timer threshold before receiving the second command, the alert manager operable for raising an error log against the initiator and reducing the frequency parameter.

19. A computer program product for handling target event status in a storage system, comprising:
one or more computer-readable storage media and program instructions collectively stored on the one or more computer-readable storage media, the program instructions executable by a processor to cause the processor to perform a method comprising:
determining, at a target, a condition;
analysing, by the target, the condition to determine a first event status associated with the condition;
in response to receiving, at the target, a first command of a set of commands from an initiator, providing, by the target, the first event status to the initiator;
monitoring, by the target, the condition;
in response to determining that the condition is not resolved, determining, by the target, a second event status; and
in response to receiving, at the target, a second command of a subset of the set of commands from the initiator, providing, by the target, the second event status to the initiator.

20. The computer program product of claim 19, wherein monitoring the condition further comprises monitoring initiator operations.
